(19) United States
(12) Patent Application Publication
(10) Pub. No.: US 2007/0095040 A1
(43) Pub. Date: May 3, 2007

(54) Ergonomic device and method for steering a riding mower

(75) Inventor: James E. Berkeley, Pineville, NC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/262,380

(22) Filed: Oct. 28, 2005

(51) Int. Cl. A01D 69/00

(52) U.S. Cl. 56/10.8

(57) ABSTRACT

A riding mower steering system includes an arm rest extension rotatably connectable to a seat arm rest. A hinge device permits at least upward and downward rotation of the arm rest extension and temporarily fixing a plurality of rotation orientations. A steering wheel is rotatably mounted to the arm rest extension. The steering wheel has a diameter adapted for single handed spanning by an operator. The hinge device is positioned to correspond to an operator wrist location and is rotatable upward and downward to accommodate a desired wrist angle with respect to the arm rest. A drive-by-wire control device is connectable to the steering wheel.

### TECHNICAL FIELD

The present teaching relates in general to riding mowers and more specifically to a device and method for steering a riding mower.

### BACKGROUND

Riding mowers commonly provide a steering wheel to manually control the direction of the mower. For fixed position steering wheel applications, access for the operator to a driver's seat is provided between the seat and the steering wheel, which generally does not provide flexibility for significantly adjusting the steering wheel position for operator comfort.

In some designs, the steering wheel is connected to an articulated post which can be swung toward and away from the driver. The articulated post design allows the entire steering wheel and post to be moved out of the operator's path to access or dismount the mower. Known articulated post designs also allow the operator to adjust the steering wheel location for comfort and for access/egress from the mower. Drawbacks of known articulated post designs include increased cost and complexity to rotatably mount the articulated post and the general lack of access to mower components on the side where the post is mounted.

Riding mower steering wheels are commonly large enough for two-hand operation, to create enough force by the operator to manually control the direction of the mower. Drawbacks of using large handwheels are the increased number of rotations required from stop to stop which effects turning speed, and the interference with access to and egress from the mower inherent with a larger handwheel.

### SUMMARY

According to several embodiments, a steering system positionable proximate to a seat includes an arm rest extension rotatably connectable to a seat arm rest. A hinge device permits at least upward and downward rotation of the arm rest extension and temporarily fixing a plurality of rotation orientations. A steering wheel is rotatably mounted to the arm rest extension. The steering wheel has a diameter adapted for single handed rotation by an operator. The hinge device is positioned to correspond to an operator wrist location and is rotatable a least upward and downward to accommodate a desired wrist angle with respect to the arm rest.

According to other embodiments, a drive-by-wire control device is connectable to the steering wheel. The drive-by-wire control device is adapted to convert an angular rotation of the steering wheel into an electrical signal. The electrical signal is used to control an operating speed of an electric motor used to rotate a steerable wheel.

According to still other embodiments, a selector switch is operable to select between a first and a second operating ratio of the steering wheel. The first operating ratio corresponds to a first quantity of steering wheel turns selectable for a mower cutting operation. The second operating ratio corresponds to a second quantity of steering wheel turns which is greater than the first quantity of steering wheel turns. The second operating ratio is selectable for a mower transfer operation.

According to still other embodiments, a method for steering a riding mower includes a step of positioning a steering wheel on a first handed-side of a seat, the steering wheel including a diameter adapted for single handed engagement by an operator. The method also includes a step of rotating the arm rest extension to a desired rotation angle with respect to the arm rest. The method further includes a step of steering the riding mower using a single-handed operator operation.

Further areas of applicability of the present teachings will become apparent from the detailed description provided hereinafter. It should be understood that the detailed description and specific examples, while indicating various embodiments, are intended for purposes of illustration only and are not intended to limit the scope of the teachings.

### BRIEF DESCRIPTION OF THE DRAWINGS

The various embodiments will become more fully understood from the detailed description and the accompanying drawings, wherein:

FIG. 1 is a front perspective view of a riding mower having an ergonomic device and method for steering a riding mower according to various embodiments;

FIG. 2 is a side elevational perspective view of the riding mower of FIG. 1;

FIG. 3 is a side elevational view of the riding mower of FIG. 1;

FIG. 4 is a side elevational view of a riding mower seat having the ergonomic device according to various embodiments; and

FIG. 5 is a side elevational view of a riding mower of several additional embodiments.

### DETAILED DESCRIPTION

The following description of several embodiments is merely exemplary in nature and is in no way intended to limit the teachings, their application, or uses. While the mower described herein will be described generally as a riding mower, the teachings herein are equally applicable to all riding mowers, including but not limited to, greens, fairway, commercial landscape, reel, or rotary riding mowers.

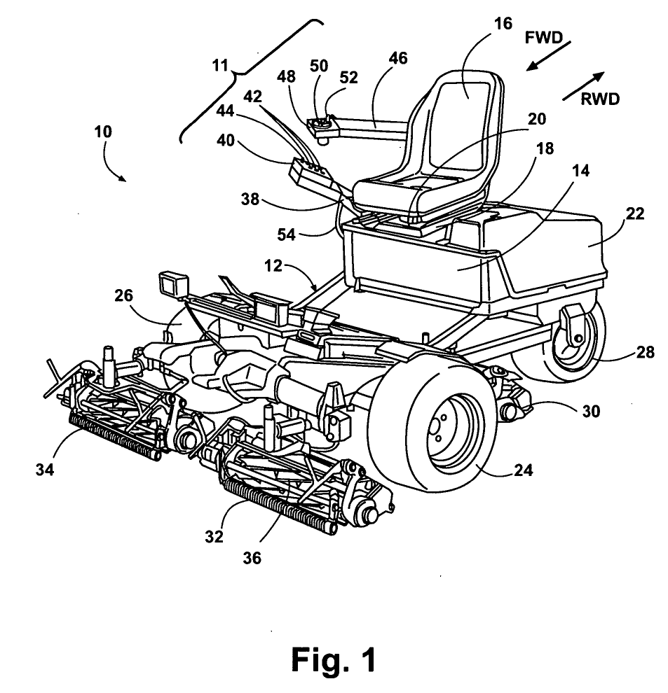

Referring generally to FIG. 1 and according to various embodiments, a riding mower 10 includes a steering system 11 supported by a mower frame 12. A structural assembly 14 supports a seat 16 and a power unit to be described later. A seat support frame 18 is positioned between structural assembly 14 and seat 16 to support seat 16. Seat 16 is adjustable in each of a forward and rearward direction using a seat adjustment device 20.

A compartment cover 22 covers a rearward section of structural assembly 14. A pair of drive wheels, including a first drive wheel 24 and a second drive wheel 26 provide rotatable propulsion for riding mower 10 in either of a forward or a rearward direction. A steerable wheel 28 is provided at the rear of lower frame 12. Riding mower 10 further includes each of a first reel cutting deck 30, a second reel cutting deck 32, and a third reel cutting deck 34. Each of the first, second and third reel cutting decks, 30, 32, 34 include a reel blade assembly 36. It will be apparent to a person of skill in the art that the reel-type cutting decks can be replaced by other known cutting assemblies including rotary blade cutting assemblies without departing from the scope of the present invention.

A support post 38 extends from one side of seat 16, and according to some embodiments, from a right side. The “sides” referred to herein for riding mower 10 are identified for convenience as a right side and a left side with respect to an operator seated in seat 16 and facing forward. Support post 38 supports a controller 40. Controller 40 includes a plurality of controls 42 and a steering ratio selector switch 44. Controls 42 can be switches, knobs, or the like used to control the cutting height of each of the reel blade assemblies 36, as well as to select between cutting and non-cutting positions for each of the first, second and third reel cutting decks 30, 32, 34. An operator using controls 42 can also select a forward or reverse operating direction for riding mower 10. An arm rest 46 is rotatably connected to seat 16. Arm rest 46 includes an arm rest extension 48 which is rotatably connected to a distal end of arm rest 46 and positioned to approximately a hand location of the operator. A steering wheel 50 is rotatably supported by arm rest extension 48 which is rotated by the operator to control the direction of riding mower 10. In some embodiments, steering wheel 50 also includes a speed knob 52 for rapidly rotating steering wheel 50.

In further embodiments, steering wheel 50 has a diameter of approximately 5 inches (12.7 cm). The term “diameter” as used herein is intended to include shapes such as but not limited to circular, oval, polygonal and other geometric shapes measurable either by a diameter (or radius), or by maximum span dimension if steering wheel 50 is not circular. It is desirable to minimize the diameter of steering wheel 50 to maximize the accessibility of an operator for gaining access to or exiting from seat 16. It is therefore desirable to maintain the diameter of steering wheel 50 substantially equal to or less than 5 inches (12.7 cm). Diameters for steering wheel 50 larger than 5 inches (12.7 cm) can also be used including diameters up to approximately 7 inches (17.8 cm). The location of steering wheel 50 is also selected to promote single-handed operation of steering wheel 50 by an operator of riding mower 10. In the embodiments shown in FIG. 1, arm rest 46 is positioned on a right-hand side of seat 16. The arm rest position is not limited to any side of seat 16, therefore arm rest 46 can also be positioned on a left-hand side of seat 16.

Arm rest extension 48 is connected to structure such as arm rest 46 or similar structure connected to seat 16 such that arm rest extension 48 with steering wheel 50 is directly translatable in either a forward or rearward direction if seat 16 is adjusted in either the forward or rearward direction. This ensures that steering wheel 50, once adjusted to a desirable location by the operator, be retained in the same orientation relative to the operator even if seat 16 is subsequently adjusted forward or rearward during use of riding mower 10. Support post 38 with controller 40 mounted thereon in some embodiments is also connectable to structure of seat 16 which translates with any forward or rearward motion of seat 16, similar to arm rest extension 48. This ensures that controller 40 is retained in a similar orientation to arm rest extension 48 and steering wheel 50 for ease of access to the plurality of controls 42 and steering ratio selector switch 44 by the operator.

To permit displacement of seat 16 and support post 38 with respect to structural assembly 14, a flexible wiring harness 54 is provided to accommodate relative displacement between support post 38 and structural assembly 14 and therefore allows frequent repositioning of seat 16. A similar flexible wiring harness (not shown) is provided within arm rest 46 to provide electrical communication for operation of steering wheel 50. As referred to herein, a forward direction is defined as an operator facing direction or motion of seat 16 toward first and second drive wheels 24, 26. A rearward direction is defined as the direction from seat 16 toward steerable wheel 28 or a motion of seat 16 toward steerable wheel 28.

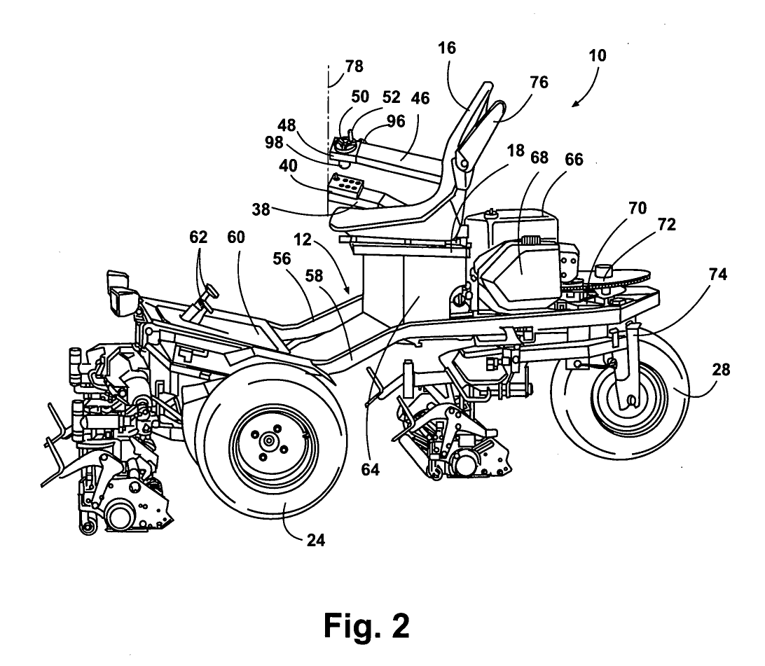

Referring generally now to FIG. 2, lower frame 12 further includes a first frame member 56 and a generally parallel second frame member 58. First and second frame members 56, 58 support a foot rest platform 60 having one or more pedals 62 which are displaceable relative to foot rest platform 60. Pedals 62 are known in the art and can include items such as a throttle control pedal and a break pedal, and can further include a clutch pedal. First and second frame members 56, 58 also support a seat support structure 64 which also supports seat 16 from seat support frame 18. In some embodiments, first and second frame members 56, 58 further support a power unit 66 which in one example is a gasoline powered reciprocating engine. For the gasoline powered reciprocating engine embodiments, a fuel tank 68 is also provided. Power unit 66 can also be one or more batteries (not shown) together with an electric drive motor operable to electrically power riding mower 10.

A steering drive motor 70 supported by mower frame 12 is coupled using a gear drive assembly 72 to a steering yoke 74 for rotatably positioning steerable wheel 28 in direct response to electrical signals generated when rotating steering wheel 50. A forward-most edge of seat 16 defines a plane 78. According to several embodiments, a forward-most edge of either controller 40, arm rest extension 48 and/or steering wheel 50 are maintained substantially parallel to, or rearward of plane 78 to maximize operator access to seat 16. A second arm rest 76 can also be provided for seat 16 on an opposed side of seat 16 from arm rest 46. Second arm rest 76 can be rotatably mounted to seat 16 and positioned between the stowed or upward position shown in FIG. 2 and an extended or substantially horizontal position similar to arm rest 46 (not shown). Components of steering system 11 are maintained substantially parallel with or rearward of plane 78 to maximize access by an operator to seat 16 and for operator egress from seat 16 from either side of riding mower 10, without the need to move arm rest 46, second arm rest 76, or steering wheel 50 out of the entrance or egress path of the operator. Further, because controller 40, arm rest 46, arm rest 76 and steering wheel 50 each move in direct response to motion of seat 16, operator access to seat 16 is provided for any position of seat 16.

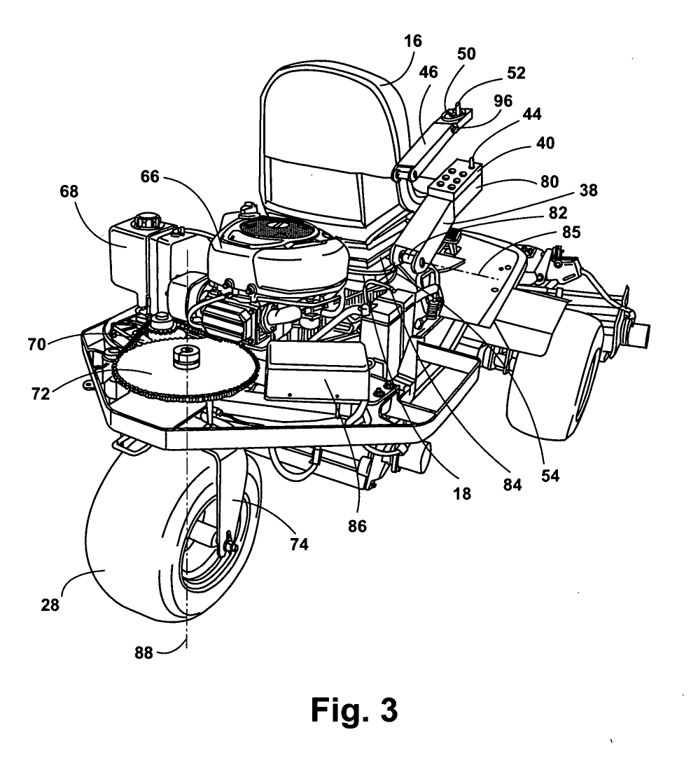

As best seen in reference to FIG. 3, to maintain the relative position of controller 40 with respect to seat 16 and arm rest 46 (only partially shown in FIG. 3 for clarity), a support tube 80 is connected using a fastener assembly 82 to a sliding seat frame 84. Sliding seat frame 84 in turn is slidably mounted to seat support frame 18. Seat 16, arm rest 46, controller 40 and support tube 80 are each directly or indirectly connected to sliding seat frame 84 and therefore move in unison with sliding seat frame 84 and seat 16. In other embodiments, fastener assembly 82 is a rotatable fastener assembly allowing rotation of support tube 80 about an access of rotation 85 defined by fastener assembly 82. When support tube 80 is rotated in addition to arm rest 46, further increased access to seat 16, as well as increased access to sliding seat frame 84 and seat support frame 18 for maintenance is provided.

In some embodiments, an electrical power transfer unit 86 is provided to control electrical signals and electrical power for controller 40, steering wheel 50 and/or steering driving motor 70. A voltage and/or current applied to steering drive motor 70 rotates steerable wheel 28 about an axis of rotation 88. Because riding mower 10 is operable for both slower speed cutting operation as well as faster speed transfer operation (with the cutting units inoperable and generally stowed), steering ratio selector switch 44 is provided to allow the operator to select between different turning ratio signals for each of a cutting operation and a mower rapid transfer operation. Selecting different turning ratio signals controls for example the sensitivity of steering wheel 50 to operator rotation. For rapid transfer operation, reduced sensitivity is desirable, and for cutting operation increased sensitivity is desirable. Steering sensitivity can be adjusted by changing the total rotational range of steering wheel 50.

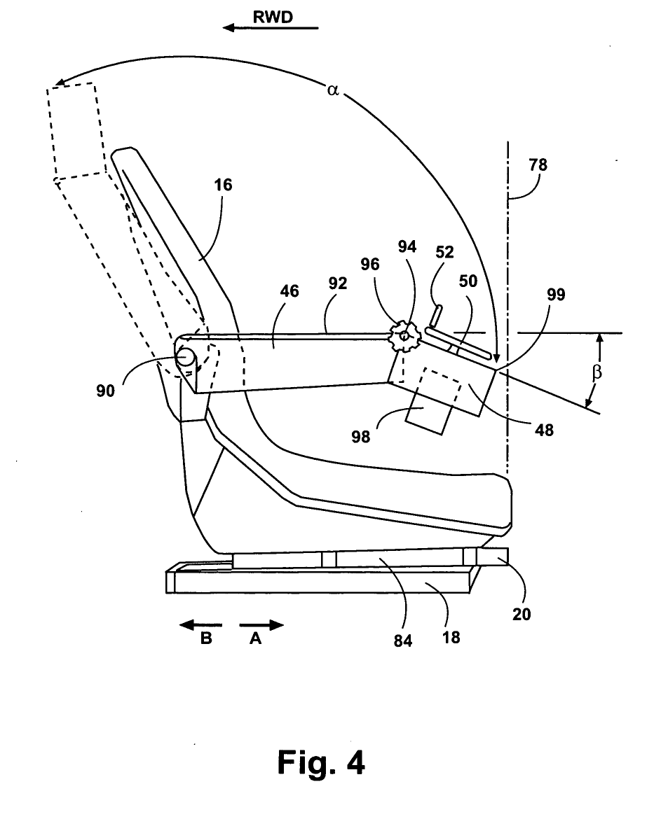

Referring now generally to FIG. 4, an exemplary side elevation view of seat 16 identifies an arc of rotation α for arm rest 46. In some embodiments, arc of rotation α ranges from approximately 90 to 110 degrees, preferably exceeding 90 degrees to stabilize arm rest 46 in a stowed position. Arm rest 46 is rotatably connectable to seat 16 using a rotation joint 90 and is positionable between the stowed position (shown in phantom) and an extended position where steering wheel 50 is accessible for use by the operator. Arm rest 46 can further include a pad member 92 to support a forearm of the operator. A hinge member 94 is positioned proximate to a wrist location of the operator. Hinge member 94 allows rotation of arm rest extension 48 about at least an arc of rotation β relative to arm rest 46. A friction lock knob 96 is provided for the operator to select a comfortable arc of rotation β and temporarily frictionally engage arm rest extension 48 to arm rest 46 at the desired angle β.

Although arc of rotation β is shown below a horizontal plane defined by pad member 92 of arm rest 46, other embodiments are not limited to this downward direction arc of rotation β. Arc of rotation β can also include rotation of arm rest extension 46 above the plane defined by arm rest 46 at the discretion of the operator. Still further, hinge member 94 can include a “ball type” hinge, which permits rotational movement of arm rest extension 48 about multiple planes of rotation in addition to arc of rotation β.

The configuration shown for friction lock knob 96 is discretionary with the designer. The size and/or diameter of friction lock knob 96 is minimized to provide maximum unrestricted access of the operator to steering wheel 50 and speed knob 52 for full rotation of steering wheel 50. A lever, a rounded knob, or a similar device made of a polymeric or metal material can be used for friction lock knob 96. A forward-most point 99 of arm rest extension 48 is preferably restricted by a length of arm rest 46 so that forward-most point 99 is positioned either parallel with or rearward of plane 78 as previously described. Through the use of seat adjustment device 20, sliding seat frame 84, together with seat 16 and arm rest 46, are collectively movable in either a forward direction “A” or a rearward direction “B” relative to seat support frame 18. Seat support frame 18 is rigidly supported to structural assembly 14 which is itself rigidly supported to mower frame 12.

A rotational sensor 98 is supported by arm rest extension 48 and connectable to steering wheel 50. Rotational sensor 98 in some embodiments of the invention produces a voltage output and current for a given number of revolutions per minute of steering wheel 50. For example, rotational sensor 98 can provide a five volt DC output signal for every one thousand revolutions per minute of steering wheel 50. Rotational sensor 98 does not generate a voltage/current signal when steering wheel 50 is stationary. The output signal voltage and current of rotational sensor 98 can be connected to controller 40 and/or to electrical power transfer unit 86, to use the output signal to control an electrical current to steering drive motor 70, which in turn rotates steerable wheel 28. It should be apparent that multiple types of rotational sensors 98 can be used within the scope of the present invention.

By using the electrical output signal of rotational sensor 98, a “drive-by-wire” system is provided for steering system 11 which eliminates the need for a large diameter (greater than approximately 7 inches (17.8 cm)) two-handed steering wheel for riding mower 10. A reduction in diameter for steering wheel 50 and single-handed operation of steering wheel 50 are therefore provided for riding mower 10. Steering wheel 50 can also be positioned to either a right or a left side of seat 16 for single-handed operation by the operator. In one or more embodiments, rotational sensor 98 is available from the Pittman Corporation and is also known as a tach generator.

To accurately control riding mower 10 during the rapid transfer condition, a slow ratio steering position of steering ratio selector switch 44 is selected. Fast or slow ratio steering is defined herein as the number of turns of steering wheel 50 required from lock-to-lock. Slow ratio steering reduces steering sensitivity of steering wheel 50 by increasing the number of turns of steering wheel 50 from lock-to-lock. Reducing steering sensitivity prevents minor changes in position of steering wheel 50 from creating a rapid steering change in riding mower 10. For example only, slow ratio steering for riding mower 10 can provide for two complete turns or rotations of steering wheel 50 from lock-to-lock.

In contrast, when riding mower 10 is used in the cutting operation with each of first, second and third reel cutting decks, 30, 32, 34 operational for grass cutting, steering wheel 50 provides complete turning capability of riding mower 10 with fewer complete turns. For example only, the quick ratio steering selection position of steering ratio selector switch 44 can provide a single turn lock-to-lock rotation of steering wheel 50. This permits an operator to rapidly turn riding mower 10 with reduced rotational motion of steering wheel 50 when riding mower 10 is operated during the generally slower speed cutting operation, for both forward and reverse directions. The difference between fast and slow ratio steering can be provided for example by switching to different windings of rotational sensor 98, or by changing the output voltage.

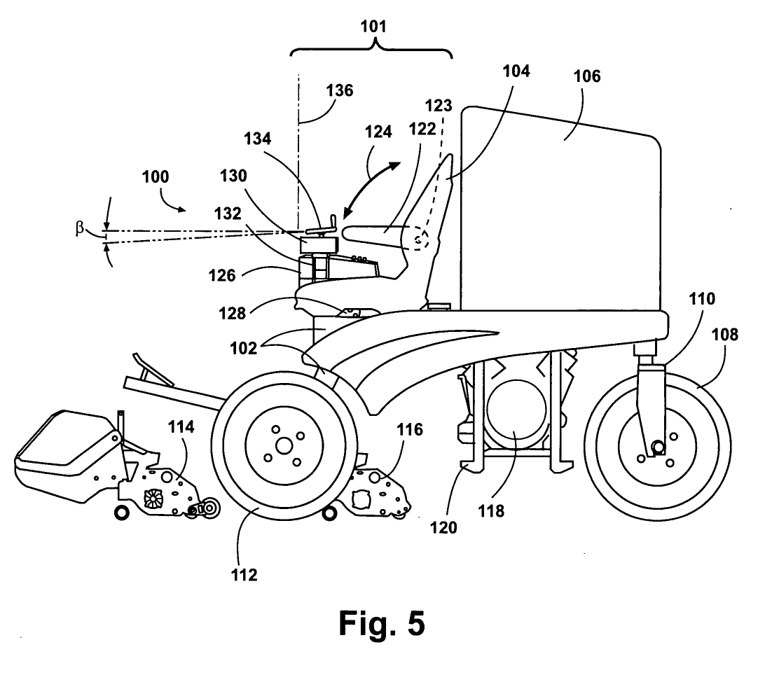

Referring now to FIG. 5, in some embodiments, a riding mower 100 includes a steering system 101. Riding mower 100 provides a frame 102 supporting a seat 104 and a grass clipping collection housing 106. Similar to riding mower 10, riding mower 100 includes a steerable wheel 108 rotatably supported by a yoke 110, and a pair of drive wheels 112 (only one is visible in this view). At least one forward positioned cutting deck 114, and a mid positioned cutting deck 116 are mounted to frame 102 for grass cutting operations of riding mower 100. A power unit 118 is suspended from frame 102 by a power unit support frame 120.

An arm rest 122 is rotatably coupled to seat 104 and is rotatable about an arc of rotation 124 from the extended position shown to an upright or stowed position (not shown). A controller 126, similar to controller 40, is structurally supported by a sliding seat support frame 128. An arm rest extension 130 is also connected to sliding seat support frame 128 by an extension support assembly 132. Arm rest extension 130 rotatably supports a steering wheel 134 similar to steering wheel 50. Arm rest extension 130 is rotatably supported to extension support assembly 132 similar to the rotatable support of arm rest extension 48 to arm rest 46. This permits an angle of rotation of steering wheel 134 and arm rest extension 130 to be varied with respect to arm rest 122.

Steering system 101 primarily differs from steering system 11 in that arm rest extension 130 and controller 126 are commonly supported independent of arm rest 122. Rotation of arm rest 122 about an arm rest axis of rotation 123 is therefore independent of any motion, or angular orientation, of steering wheel 134. It is desirable, however, that a distal end of arm rest 122 be positioned relative to a wrist of the operator and the angular orientation of steering wheel 134 be adjustable to suit the desired angle for operation of steering wheel 134 at the discretion of the operator, similar to the angular orientation provided by arc of rotation β for steering wheel 50. Similar to steering system 11, controller 126, arm rest extension 130 and steering wheel 134 of steering system 101 can be positioned as far forward as a plane 136 defined by a forward-most edge of seat 104, or positioned rearward of plane 136.

A steering system as herein described provides several advantages, including a “reduced diameter” steering wheel for steering a riding mower. The term “reduced diameter” as referred to herein is generally defined as a steering wheel having a maximum span (if not round) or diameter which is capable of being spanned by a single hand of an operator. For this purpose, a diameter of approximately 5 inches (12.7 cm) or smaller is assumed. Steering systems as herein described are electrically power assisted. This eliminates the need for a two-handed steering wheel to provide the amount of torque to steer the riding mower. A tach generator or similar device is provided to convert rotational motion of the steering wheel to an electrical signal, which is used to actuate an electric motor to rotate the steerable wheel. An angular orientation of the steering wheel is selectable by the operator for greatest operating comfort and relates to a bend angle of the operator's wrist. The operator can also select between a transport operation condition and a cutting operation condition, each using a different total lock-to-lock quantity of turns of the steering wheel. The reduced diameter steering wheel defined herein also allows the total assembly of the steering wheel and arm rest extension to be retained parallel with or rearward of a plane defined by a forward edge of the seat. This maximizes accessibility to or from the seat from either side of the riding mower by the operator.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A riding mower steering system, comprising:
a seat structural member having an arm rest extension rotatably connectable to the structural member;
a hinge device operable to permit at least upward and downward rotation of the arm rest extension, and operable to temporarily fix the arm rest extension in a plurality of rotation orientations; and
a steering wheel rotatably mounted to the arm rest extension, the steering wheel having a diameter adapted for single-hand spanning by an operator.

2. The steering system of claim 1, further comprising a speed knob rotatably connectable to the steering wheel.

3. The steering system of claim 1, further comprising a drive-by-wire control device connectable to the steering wheel and adapted to convert a rotational motion of the steering wheel into an electrical signal.

4. The steering system of claim 1, wherein the steering wheel further comprises a diameter ranging up to approximately 5 inches (12.7 cm).

5. The steering system of claim 1, further comprising an adjustment device operable with the hinge device to each of temporarily fix the arm rest rotation orientation and release the arm rest extension for rotatable adjustment.

6. The steering system of claim 1, wherein a forward-most edge of the seat defines a vertical plane and a forward-most location of a distal end of the arm rest extension is restrictable to one of parallel with and rearward of the vertical plane to maximize operator accessibility to the seat.

7. The steering system of claim 1, wherein the seat structural member further comprises an arm rest rotatably connectable to the seat, the arm rest extension being rotatably connectable to a distal end of the arm rest.

8. The steering system of claim 1, wherein the seat structural member further comprises:
a seat frame movable in conjunction with the seat; and
a structural assembly connectable to the seat frame and operable to rotatably support the arm rest extension.

9. The steering system of claim 1, wherein the hinge device is positioned to correspond to placement of a wrist of the operator and the arm rest extension is rotatably adjustable to a desired angle of the arm rest extension with respect to the seat structural member.

10. A riding mower steering system, comprising:
an arm rest;
an arm rest extension rotatably connectable to the arm rest;
a rotation device operable to permit at least upward and downward rotation of the arm rest extension and further operable to temporarily fix the arm rest extension in a plurality of rotation orientations with respect to the arm rest; and
a steering wheel rotatably mounted to the arm rest extension, the steering wheel having a diameter adapted for single handed engagement by an operator;
wherein the rotation device is positioned to correspond to a wrist of the operator and is rotatably adjustable to accommodate a desired arm rest extension angle with respect to the arm rest.

11. The steering system of claim 10, further comprising a drive-by-wire control device electrically connectable to the steering wheel and adapted to convert an angular rotation of the steering wheel into an electric signal.

12. The steering system of claim 11, wherein the drive-by-wire control device further comprises a tach generator operable to generate a voltage upon rotation of the steering wheel.

13. The steering system of claim 12, further comprising a drive motor electrically connected to the tach generator and operable to rotate a steerable wheel.

14. The system of claim 10, further comprising a selector switch operable to select between a first and a second operating ratio of the steering wheel.

15. The system of claim 14, wherein the first operating ratio corresponds to a first quantity of steering wheel turns selectable for a mower cutting operation and the second operating ratio corresponds to a second quantity of steering wheel turns being greater than the first quantity of steering wheel turns, the second operating ratio being selectable for a mower transfer operation.

16. The steering system of claim 10, wherein the steering wheel further comprises a diameter ranging up to approximately 5 inches (12.7 cm).

17. The steering system of claim 10, further comprising an adjustment device operable with the hinge device to each of temporarily fix the arm rest rotation orientation and release the arm rest extension for rotatable adjustment.

18. The steering system of claim 10, further comprising a seat rotatably supporting the arm rest, wherein a forward-most edge of the seat defines a vertical plane and a forward-most location of a distal end of the arm rest extension is restrictable to one of parallel with and rearward of the vertical plane to maximize operator accessibility to the seat.

19. A riding mower steering system positionable proximate to a mower seat, comprising:
an arm rest rotatably connectable to the seat;
an arm rest extension rotatably connectable to the arm rest;
a rotation device operable to permit at least upward and downward rotation of the arm rest extension and further operable to temporarily fix the arm rest extension in a plurality of rotation orientations with respect to the arm rest;
a steering wheel rotatably mounted to the arm rest extension, the steering wheel having a diameter adapted for single handed engagement by an operator; and
a drive-by-wire control device electrically connectable to the steering wheel and adapted to convert an angular rotation of the steering wheel into an electric signal;
wherein the rotation device is positioned to correspond to a wrist of the operator and is rotatably adjustable to accommodate individual ones of the rotation orientations.

20. The steering system of claim 19, further comprising a switch operable to select between a plurality of steering wheel operating ratios.

21. The steering system of claim 20, further comprising a first and a second operating ratio selectable by the switch, the first operating ratio being, and the second operating ratio being

22. The steering system of claim 20, further comprising a controller positionable proximate to the arm rest extension, the controller adapted to support the switch.

23. The steering system of claim 19, wherein the steering wheel further comprises a diameter ranging up to approximately 5 inches (12.7 cm).

24. A method for steering a riding mower, the riding mower including a mower seat, an arm rest connectable to the seat, an arm rest extension, a steering wheel mounted to the arm rest extension, and a rotation device operable to permit at least upward and downward rotation of the arm rest extension, the method comprising:
positioning the steering wheel on a first handed side of the seat, the steering wheel having a diameter adapted for single-hand spanning by an operator;
rotating the arm rest extension to a desired rotation angle with respect to the arm rest; and
steering the riding mower using a single-handed operator operation.

25. The method of claim 24, further comprising rotating the steering wheel using a speed knob connected to the steering wheel.

26. The method of claim 24, further comprising selecting a turning ratio of the steering wheel dependent upon an operating condition of the riding mower.

27. The method of claim 24, further comprising increasing a turning ratio of the steering wheel for a transfer operation of the riding mower.

28. The method of claim 24, further comprising decreasing a turning ratio of the steering wheel for a cutting operation of the riding mower.

29. The method of claim 24, further comprising:
converting a rotational motion of the steering wheel into an electrical signal; and
applying the electrical signal to rotate a steerable wheel of the riding mower.

30. The method of claim 24, further comprising connecting the hand rest extension to a seat structure translatable with the seat to fix the arm rest extension relative to the arm rest during the steering step.

31. The method of claim 24, further comprising temporarily fixing the arm rest extension at the desired rotation angle.
